(19) United States
(12) Patent Application Publication
(10) Pub. No.: US 2012/0051051 A1
(43) Pub. Date: Mar. 1, 2012

(54) SOLID STATE LUMINAIRE WITH REDUCED OPTICAL LOSSES

(75) Inventors: Rick Kauffman, Buford, GA (US); Donald Sipes, Colorado Springs, CO (US); Donald VanderSluis, Sarasota, FL (US); Robert Fugerer, Lutz, FL (US)

(73) Assignee: SUNOVIA ENERGY TECHNOLOGIES, INC., Sarasota, FL (US)

(21) Appl. No.: 13/318,069

(22) PCT Filed: Apr. 28, 2010
(86) PCT No.: PCT/US10/32818

§ 371 Date: Oct. 28, 2011

Related U.S. Application Data
(60) Provisional application No. 61/173,428, filed on Apr. 28, 2009.

(51) Int. Cl. F21V 5/04; F21V 29/00

(52) U.S. Cl. 362/244; 362/235; 362/335

(57) ABSTRACT

Light assemblies are disclosed which incorporate mechanisms by which light losses due to angle of incidence from a lens covering an LED, or other solid state source or sources, are reduced. Assemblies may incorporate low-loss covers in luminaires originally designed to utilize LEDs or in an LED retrofit device or mechanism designed to convert an existing luminaire that uses a traditional light source or sources into a luminaire that uses LEDs. The low loss covers include discrete surfaces that correspond to individual LEDs, small arrays of LEDs, or small groups of LEDs. The discrete surfaces may be substantially orthogonal to the rays of light that are incident upon the surfaces from the associated LED(s) to reduce the amount of light reflected back to the associated LED(s).

### CROSS-REFERENCE TO RELATED APPLICATIONS

This application claims priority to U.S. Provisional Patent Application No. 61/173,428, filed on Apr. 28, 2009, the entire disclosure of which is incorporated herein by reference.

This application is also related to co-pending U.S. patent application Ser. No. 12/767,698, filed on Apr. 26, 2010, entitled “Solid State Lighting Unit Incorporating Optical Spreading Elements”; and U.S. patent application Ser. No. ______, filed on Apr. 28, 2010, entitled “Solid State Luminaire Having Precise Aiming and Thermal Control,” and identified as Attorney Docket No. 51119.830012.US1; and U.S. patent application Ser. No. ______, filed on Apr. 28, 2010, entitled “Retrofit System For Converting An Existing Luminaire Into A Solid State Lighting Luminaire,” and identified as Attorney Docket No. 51119.830013.US1. The disclosures of each of these related applications are incorporated herein by reference.

### FIELD

The present disclosure relates to solid state lighting, and optical components used in solid state lighting to achieve desired illumination patterns.

### BACKGROUND

Lighting systems traditionally use various different types of illumination devices, commonly including incandescent lights, fluorescent lights, and Light Emitting Diode (LED) based lights. LED based lights generally rely on multiple diode elements to produce sufficient light for the needs for a particular application of the particular light or lighting system. As an approach to offset the ever increasing price of energy and make a meaningful indent to the production of greenhouse gases, LED lighting offers great promise in this regard. With efficacies approaching 150 lumens per Watt, and lifetimes at over 50,000 Hours, LEDs and lighting products based on LED technology may potentially make significant inroads in the lighting market in residential and commercial, indoor and outdoor applications.

LED based lights offer significant advantages in efficiency and longevity compared to, for example, incandescent sources, and produce less waste heat. For example, if an ideal solid-state lighting device were to be fabricated, the same level of luminance can be achieved by using merely 1/20 of the energy that an equivalent incandescent lighting source requires. LEDs offer greater life than many other lighting sources, such as incandescent lights and compact fluorescents, and contain no environmentally harmful mercury that is present in fluorescent type lights. LED based lights also offer the advantage of instant-on and are not degraded by repeated on-off cycling.

As mentioned above, LED based lights generally rely on multiple LED elements to generate light. An LED element, as is well known in the art, is a small area light source, often with associated optics that shape the radiation pattern and assist in reflection of the output of the LED. LEDs are often used as small indicator lights on electronic devices and increasingly in higher power applications such as flashlights and area lighting. The color of the emitted light depends on the composition and condition of the semiconducting material used to form the junction of the LED, and can be infrared, visible, or ultraviolet.

Within the visible spectrum, LEDs can be fabricated to produce desired colors. For applications where the LED is to be used in area lighting, a white light output is typically desirable. There are two common ways of producing high intensity white-light LED. One is to first produce individual LEDs that emit three primary colors (red, green, and blue), and then mix all the colors to produce white light. Such products are commonly referred to as multi-colored white LEDs, and sometimes referred to as RGB LEDs. Such multi-colored LEDs generally require sophisticated electro-optical design to control the blend and diffusion of different colors, and this approach has rarely been used to mass produce white LEDs in the industry to date. In principle, this mechanism has a relatively high quantum efficiency in producing white light.

A second method of producing white LED output is to fabricate a LED of one color, such as a blue LED made of InGaN, and coating the LED with a phosphor coating of a different color to produce white light. One common method to produce such and LED-based lighting element is to encapsulate InGaN blue LEDs inside of a phosphor coated epoxy. A common yellow phosphor material is cerium-doped yttrium aluminum garnet (Ce3+:YAG). Depending on the color of the original LED, phosphors of different colors can also be employed. LEDs fabricated using such techniques are generally referred to as phosphor based white LEDs. Although less costly to manufacture than multi-colored LEDs, phosphor based LEDs have a lower quantum efficiency relative to multi-colored LEDs. Phosphor based LEDs also have phosphor-related degradation issues, in which the output of the LED will degrade over time. Although the phosphor based white LEDs are relatively easier to manufacture, such LEDs are affected by Stokes energy loss, a loss that occurs when shorter wavelength photons (e.g., blue photons) are converted to longer wavelength photons (e.g. white photons). As such, it is often desirable to reduce the amount of phosphor used in such applications, to thereby reduce this energy loss. As a result, LED-based white lights that employ LED elements with such reduced phosphor commonly have a blue color when viewed by an observer.

Various other types of solid state lighting elements may also be used in various lighting applications. Quantum Dots, for example, are semiconductor nanocrystals that possess unique optical properties. The emission color of quantum dots can be tuned from the visible throughout the infrared spectrum. This allows quantum dot LEDs to create almost any output color. Organic light-emitting diodes (OLEDs) include an emitting layer material that is an organic compound. To function as a semiconductor, the organic emitting material must have conjugated pi bonds. The emitting material can be a small organic molecule in a crystalline phase, or a polymer. Polymer materials can be flexible; such LEDs are known as PLEDs or FLEDs.

In an ideal situation, luminaires may be designed to optimally incorporate LEDs and make full use of the various properties and advantages for the particular LED that is incorporated into the luminaire. However, in many cases it may be desirable to retrofit an existing light housing to incorporate a solid state light unit. For example, it may desired to preserve the housing of a luminaire for re-use so as to avoid the cost of completely replacing the entire light housing, which can have considerable cost.

### SUMMARY

The present disclosure provides embodiments incorporating mechanisms by which light losses due to angle of incidence from a lens covering an LED, or other solid state source or sources are reduced. Embodiments are provided that incorporate low-loss covers in luminaires originally designed to utilize LEDs or in an LED retrofit device or mechanism designed to convert an existing luminaire that uses a traditional light source or sources into a luminaire that uses LEDs. The low loss covers of embodiments described herein include discrete surfaces that correspond to individual LEDs, small arrays of LEDs, or small groups of LEDs. The discrete surfaces in some exemplary embodiments are substantially orthogonal to the rays of light that are incident upon the surfaces from the associated LED(s).

One aspect of the present disclosure provides a solid state lighting assembly, comprising: (a) a optical assembly that comprises a plurality of discrete mounting surfaces; (b) a plurality of solid state light elements mounted to respective mounting surfaces each having a respective aiming axis, light emitted by each solid state light element directed along said aiming axis; and (c) a lens comprising a plurality of discrete planar facets, each of which correspond to a respective discrete mounting surface, a plane of each facet being substantially orthogonal to the aiming axis of the associated solid state light element. The optical assembly may further comprise a heat sink to facilitate the transfer of heat away from the solid state light elements. The plurality of solid state light elements may comprise light emitting diode (LED) light elements. The plurality of solid state light elements may also each comprise an LED module that comprises a plurality of LEDs. In some embodiments, at least some of the plurality of solid state light elements comprise an LED module and a secondary optic optical lens. The secondary optic optical lens may include, for example, at least one of a collimating lens, a spreading lens, and a steering lens. In an exemplary embodiment, each of the plurality of discrete facets corresponds to an associated discrete mounting surface. In another exemplary embodiment, the discrete facets are substantially parallel to a plane of an associated mounting surface. In still another exemplary embodiment, each of the plurality of solid state light elements provides light output along a respective primary axis, and each of the discrete facets has an associated adjacent light element, and wherein a plane of each of the discrete facets is substantially perpendicular to the primary axis of the adjacent light element.

Another aspect of the present disclosure provides an external lens adapted to be mounted to a solid state lighting assembly having a plurality of point light sources that are mounted to a plurality of discrete mounting surfaces having different physical orientations. The external lens of this aspect includes a plurality of facets that each correspond to one of the plurality of discrete mounting surfaces, each of the facets being substantially planar and oriented in a plane that is substantially parallel to a plane of the associated mounting surface. The external lens of this aspect may have a convex shape relative to the exterior of the solid state lighting assembly when mounted thereto. Each of the plurality of discrete facets may correspond to an associated point light source, a primary axis of the associated point light surface being substantially orthogonal to the plane of the respective facet.

### BRIEF DESCRIPTION OF THE DRAWINGS

FIGS. 1A-1C illustrate optical transmission/reflection of light through a lens at differing angles of incidence;

FIG. 2 is a bottom perspective view of a solid state lighting assembly of an exemplary aspect of the disclosure;

FIG. 3 is a bottom perspective view of a faceted lens for use with a solid state lighting assembly of an exemplary aspect of the disclosure;

FIG. 4 is a side elevation view of a solid state lighting assembly of an exemplary aspect of the disclosure;

FIG. 5 is a cross-sectional illustration of the solid state lighting assembly of FIG. 4; and

FIG. 6 is an illustration of a secondary optic of various embodiments.

### DETAILED DESCRIPTION

The present disclosure recognizes that in many cases it is desirable to provide a retrofit device or mechanism designed to both fit into an existing luminaire housing designed for a non-solid-state light, while also making use of solid state light elements such as LEDs. Throughout this disclosure reference will be made to LEDs with the understanding that concepts described herein may be applied to other types of solid state light elements, such as those described above. While the luminous efficacy of high-power LEDs or other solid state lighting elements is not only very high but improving regularly. Luminaires designed around LEDs are not intended to directly compete with a traditional light source on a lumen-for-lumen basis. Rather, since the output from an LED is much more directional, LED luminaires are best designed to precisely aim and focus the directional output of LEDs in order to put the needed number of foot-candles on the ground in the most efficient manner possible. Even greater efficiencies can be achieved when the optical system of the luminaire is designed to minimize optical losses.

When attempting to retrofit an existing device, several properties related to LEDs present challenges to implementing a suitable design that accomplishes an equivalent, or better, lighting output for the housing with the originally designed light source. For example, the output from LEDs is much more directional than the output of an incandescent light or a gas discharge light, for example. Considerations related to providing adequate light from the luminaire over the entire area that is to be lighted also must be included in any design. In this regard, LED output can be efficiently utilized when the optical system of the luminaire is designed to place the correct amount of light precisely where it is desired. This may require controlled collimation of the LEDs' output, correct aiming of that collimated beam of light, and in typical applications, some of those beams need to be spread over a greater of lesser areas than other beams. Present, implementations may spread those LED beams using a spreading lens attached to a collimating lens or incorporated into the collimating lens.

Typical devices that provide protection for a light source or sources from the outside environment include lenses or other covering that light from the light source is transmitted through. These lenses or coverings are commonly composed of glass, a polymer, or blend of polymers. These protective lenses or coverings may also be constructed to act as refractive elements in luminaires with traditional light sources. Traditionally, these lenses are flat-surfaced or rounded, and secured to the housing that has the light source to provide protection to the light source from external elements, etc. In traditional non-solid state lighting applications, the non-directive nature of the light output results in relatively small impact on the overall light output performance of the assembly when coupled with a flat surfaced or rounded external lens.

As mentioned above, in order to efficiently utilize the light produced by LEDs, luminaires or luminaire retrofit devices in embodiments described herein direct the light produced by the LEDs according to the desired light output pattern for the luminaire. In an exemplary embodiment, a LED luminaire or luminaire retrofit device provides light produced by the LEDs that is directed to desired locations where light is needed by aiming the LEDs and any secondary collimating optics, and focusing the output of each light source as needed via spreading lenses to achieve the desired pattern of foot-candles on the ground. Individual spreading lenses may be attached to the collimating lens or incorporated into the top surface of a collimating lens. The LEDs and their secondary optics are then protected, in various embodiments, from the outside elements by an external lens that is faceted with some, if not all, of the facets oriented orthogonally to the aiming axis or vector of each LED.

Such an arrangement of LED light elements and secondary optics provides a desired pattern of light, where individual spreading lenses are properly selected and attached to each collimating lens, or each collimating lens incorporates a different degree of beam spread and is selected to create the required light pattern. This method provides an accurate, optically effective light pattern, and provides a great deal of flexibility to address the potential need for producing various patterns.

Such an implementation of aimed LEDs means that each LED, small array of LEDs, or group of LEDs, will be aimed in a direction different from nearby LEDs, arrays of LEDs, or groups of LEDs. The rays of light from each light source(s) consequently travels in a direction different from those of nearby light sources. This means that these rays from numerous LEDs would impinge upon a conventional protective lens at numerous different angles of incidence.

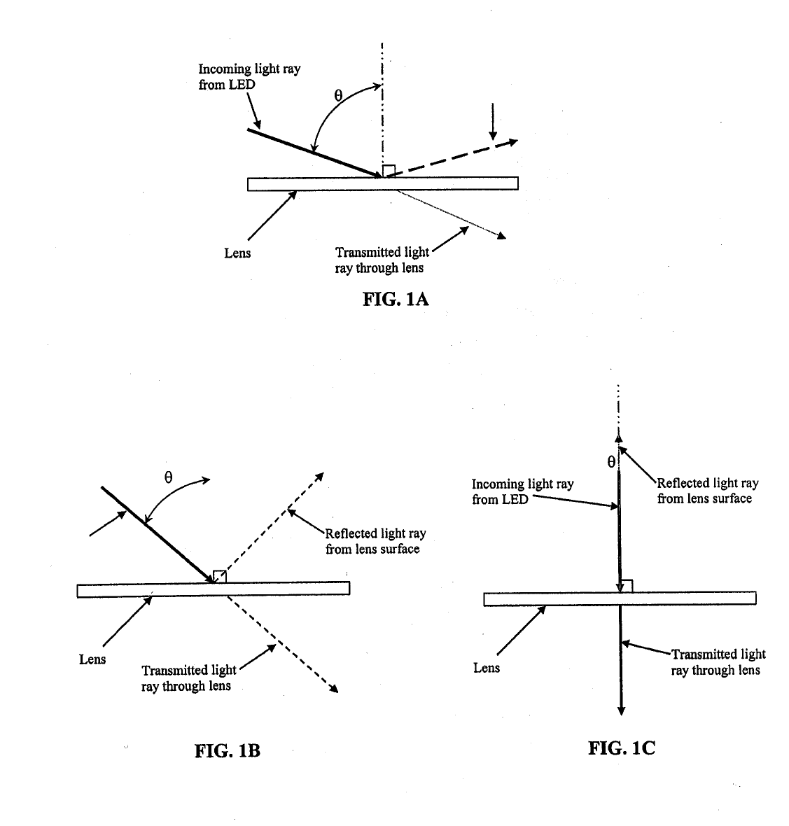

The intensity of the light transmitted through a lens varies with angle according to the Fresnel equations. Briefly, the greater the angle of an incident beam away from orthogonal to the surface of the lens, the less light is transmitted through the lens. Such a situation is illustrated in FIG. 1A. Likewise, the closer to orthogonal a ray of light is to the surface of the lens, the more of the light is transmitted through the lens, as illustrated in FIG. 1B. In cases where a ray of light is incident substantially orthogonal to the surface of a lens, substantially all of the light is transmitted through lens, as illustrated in FIG. 1C. With a conventional flat or rounded lens coupled to a LED light fixture comprising numerous LEDs aimed in differing directions, the light loss may be large enough for enough of the LEDs or small arrays of LEDs that the overall efficacy of the light assembly is significantly reduced. Embodiments described herein provide solutions to this angle-dependent light loss, and consequent loss in efficacy, by making a luminaire external lens or covering that has a plurality of surfaces for each LED, small array of LEDs, or small group of LEDs that provides angles of incidence that are closer to orthogonal than would be the case with a flat or rounded lens surface.

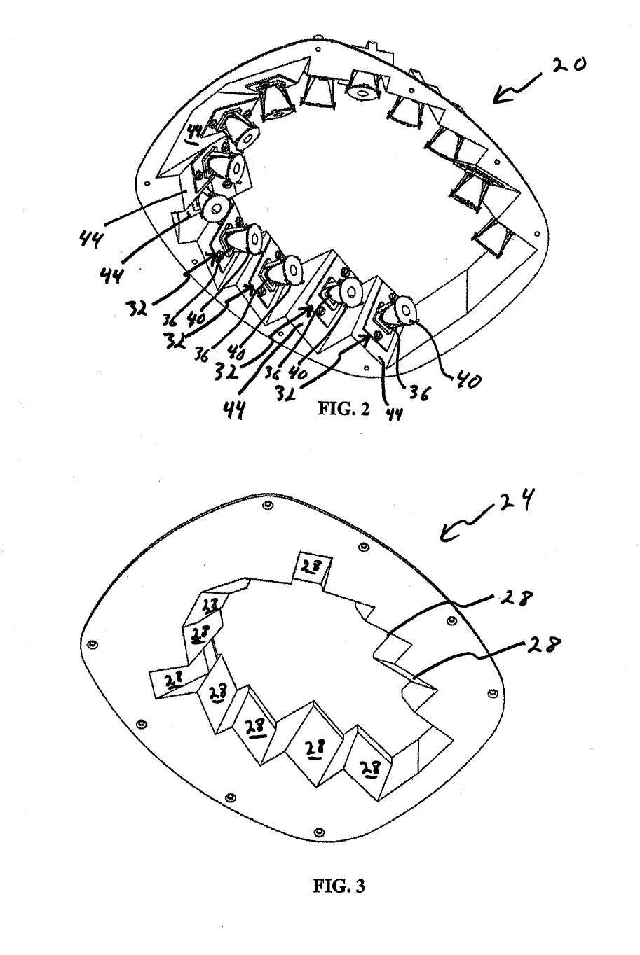

With reference to FIGS. 2 and 3, an exemplary embodiment is described in which a luminaire assembly 20 includes an external lens 24 having a plurality of facets 28. Each facet 28 in this embodiment is oriented so as to be substantially orthogonal to the primary aiming axis or vector of an associated light source 32. In this particular embodiment, each light source 32 includes one or more LED sources 36. Each light source 32 in this embodiment also includes an optic component 40 such as a collimator or spreading lens, commonly referred to as secondary optics. The LED sources may include a single LED, or a package that contains multiple LED die. Other embodiments include a multiplicity of LED packages that each contains a single LED die or multiple die. Still further embodiments may include small arrays of LEDs with all the LEDs in a given small array being aimed in substantially the same direction. In even further embodiments, small arrays of LEDs are provided with different LEDs in the array having different secondary optics 40 and are aimed in slightly different directions.

Each light source 32, in this embodiment, is mounted to a mounting surface 44. The mounting surfaces 44 are fabricated into the luminaire assembly 20 at different angles relative to one another and light sources 32 are mounted to the mounting surfaces 44 such that the primary axis of light output of the light source 32 is substantially orthogonal to the mounting surface 44. The different mounting surfaces 44 and the angles of these mounting surfaces 44 are designed to provide the output of the associated light sources 32 at different areas of the area to be illuminated, and thereby provide the desired light output pattern from the luminaire. As mentioned above, in some embodiments, some or all of the light sources 32 may include an array of LED sources 36 and secondary optics 40, such as an array of three or five light sources 32 mounted to a common substrate, such as a printed circuit board, that is mounted to the respective mounting surface. In such embodiments, the primary axis of light output of each of the light sources 32 in the array may be in substantially the same direction, or may be in slightly different directions, to provide light output at a certain intensity over an area to be illuminated by those particular light sources. In still further embodiments, the luminaire assembly 20 includes substantially fewer mounting surfaces 20, with light sources 32 mounted and aimed in different directions to provide the desired light output pattern. In these embodiments, the primary axis of light output from the light sources 32 may not be orthogonal to the mounting surface, instead being aimed in the appropriate direction through secondary optics 40 or through shims or wedges installed between the light source and mounting surface 44.

As illustrated in FIG. 3, the external protective lens 24 in this embodiment is a single piece lens manufactured using molding, casting, laser cutting or ablation, machining, mechanical forming, or vacuum forming, for example. Other embodiments include a protective lens 24 that is formed of multiple pieces or components. In some embodiments, the luminaire assembly 20 and associated protective lens 24 are configured to be “full cut-off” and meet Dark Sky requirements. Such embodiments provide that very little, if any, light is emitted above horizontal. In other embodiments, the luminaire assembly 20 and associated protective lens 24 are configured to comply with glare requirements that limit intensity of light from the luminaire in the region between 80° and 90°. Such glare requirements are commonly desired in street lighting applications, where it is undesirable to have light directly transmitted in the line of sight of an operator of a motor vehicle. The full cut-off and glare requirements are enabled by virtue of the lens of these embodiments being a “negative” lens in the luminaire design sense. That is, instead of protruding out from the body of the luminaire or retrofit device, the lens is recessed inward so that light is not scattered where it is not desired.

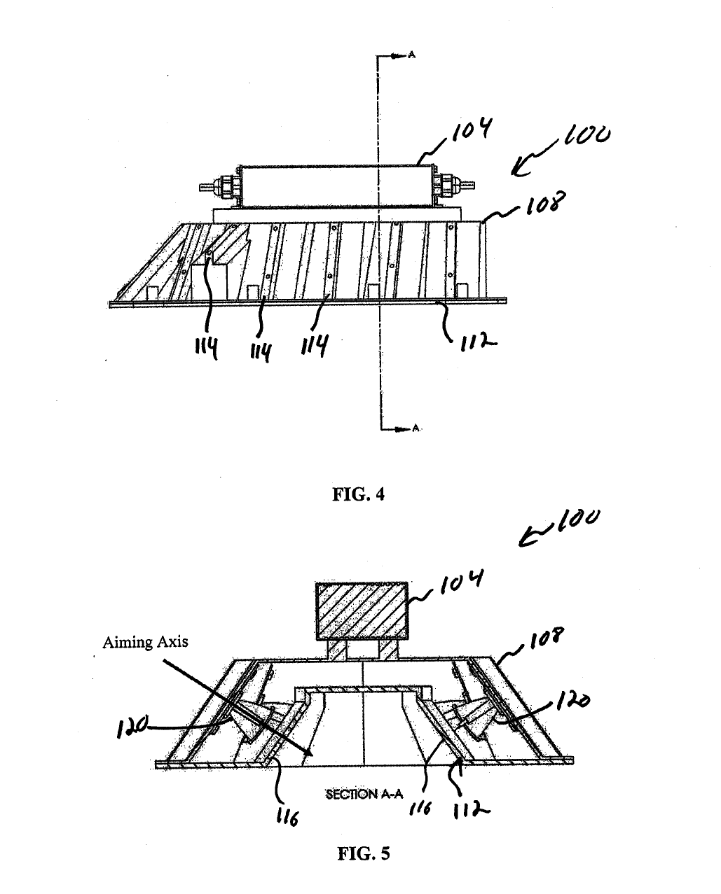

With reference now to FIG. 4, a side plan view of a lamp assembly 100 of an embodiment is illustrated. In this embodiment, the lamp assembly 100 includes a power supply 104, a housing and aiming platform 108, and external protective lens 112. The aiming platform includes a number of different mounting surfaces, such as described above, and in this embodiment also includes heat sinks 114 that are associated with each mounting surface to facilitate the transfer of heat away from an associated light element mounted to the mounting surface. The power supply 104 receives incoming AC power and converts this power in to DC power that is used to power the solid state lighting elements that are included in the housing and aiming platform 108. In some embodiments, power supply 104 is adjustable so as to provide differing power outputs based on the amount of light needed to be output from the lamp assembly 100. FIG. 5 is a cross-sectional illustration, along section A-A of FIG. 4. As can be seen from the illustrations, the protective lens 112 in this embodiment includes facets 116 that are substantially orthogonal to the aiming axis of individual lighting elements 120, which in this embodiment include an LED assembly and secondary optic.

As mentioned above, in some embodiments the lighting elements 120 may be an array of lighting elements mounted on a single substrate or printed circuit board and all sharing substantially the same aiming axis. In other embodiments, lighting elements 120 in such an array may have differing primary axes to provide light output over a broader area from the array of light elements 120. In such embodiments, the face of each facet 116 may be arranged to be substantially orthogonal to the centerline of the associated light elements 120. Light elements 120 that are aimed in directions different than the centerline of the array have light output incident on the facet at angles different than 90 degrees, but still at angles that are great enough so as to provide relatively insignificant amounts of reflected light. In other embodiments, each facet 116 may include further sub-facets, or be radiused, so as to provide angles of incidence for each light element 120 in an array that approaches 90 degrees.

Still other embodiments may provide an external lens or lenses that are faceted so as to make any or all of those facets orthogonal to the aiming axis or vector of the LED or LEDs and their associated optics that those facets protect. Other embodiments have variations on the size, number and orientation of the facets.

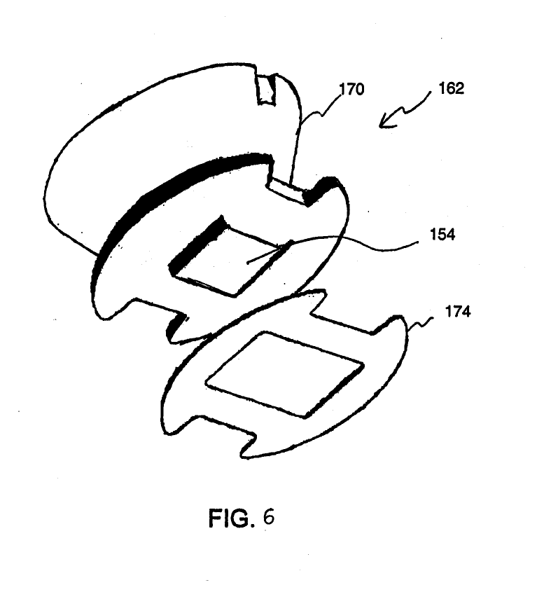

With reference now to FIG. 6, an illustration a collimating optic component 162 that is used as a secondary optic in one embodiment is discussed. The collimating optic 162 includes lens portion 170 that is adapted to receive an LED light element through aperture 154. The lens 170 is mounted to a substrate using an adhesive pad 174, in this embodiment. In some embodiments, frensel type lenses may be attached to the lens 170 to further shape the light output. As mentioned above, the secondary optic component, in combination with optical spreading and/or steering elements of other light elements, can be used to achieve a desired output by using an appropriate combination of uncollimated, narrowly collimated, wide angle and/or oval projection LED beam patterns. As will be readily understood by one of skill in the art, other types of secondary optics may be used depending upon the desired output beam of a particular light element.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A solid state lighting assembly, comprising:
a optical assembly that comprises a plurality of discrete mounting surfaces;
a plurality of solid state light elements mounted to respective mounting surfaces each having a respective aiming axis, light emitted by each solid state light element directed along said aiming axis; and
a lens comprising a plurality of discrete planar facets, each of which correspond to a respective discrete mounting surface, a plane of each facet being substantially orthogonal to the aiming axis of the associated solid state light element.

2. The solid state lighting assembly, as claimed in claim 1, wherein said optical assembly further comprises a heat sink.

3. The solid state lighting assembly, as claimed in claim 1, wherein said plurality of solid state light elements comprise light emitting diode (LED) light elements.

4. The solid state lighting assembly, as claimed in claim 1, wherein said plurality of solid state light elements each comprise an LED module that comprises a plurality of LEDs.

5. The solid state lighting assembly, as claimed in claim 1, wherein at least some of said plurality of solid state light elements comprise an LED module and a secondary optic optical lens.

6. The solid state lighting assembly, as claimed in claim 5, wherein said secondary optic optical lens comprises at least one of a collimating lens, a spreading lens, and a steering lens.

7. The solid state lighting assembly, as claimed in claim 1, wherein each of said plurality of discrete facets corresponds to an associated discrete mounting surface.

8. The solid state lighting assembly, as claimed in claim 1, wherein said discrete facets are substantially parallel to a plane of an associated mounting surface.

9. The solid state lighting assembly, as claimed in claim 1, wherein each of said plurality of solid state light elements provides light output along a respective primary axis, and each of said discrete facets has an associated adjacent light element, and wherein a plane of each of said discrete facets is substantially perpendicular to the primary axis of the adjacent light element.

10. An external lens adapted to be mounted to a solid state lighting assembly having a plurality of point light sources mounted to a plurality of discrete mounting surfaces having different physical orientations, the external lens comprising:
a plurality of facets that each correspond to one of the plurality of discrete mounting surfaces, each of said facets being substantially planar and oriented in a plane that is substantially parallel to a plane of the associated mounting surface.

11. The external lens, as claimed in claim 10, wherein the external lens has a convex shape relative to the exterior of the solid state lighting assembly when mounted thereto.

12. The external lens, as claimed in claim 10, wherein each of said plurality of discrete facets corresponds to an associated point light source, a primary axis of the associated point light surface being substantially orthogonal to the plane of the respective facet.
